(19) United States
(12) Patent Application Publication
(10) Pub. No.: US 2005/0264525 A1
(43) Pub. Date: Dec. 1, 2005

(54) Mouse pointing system/icon identification system

(76) Inventors: Charles R. Adams, Baltimore, MD (US); Harvey C. Nathanson, Pittsburgh, PA (US); Robert S. Howell, Silver Spring, MD (US)

Correspondence Address: BIRCH STEWART KOLASCH & BIRCH, PO BOX 747, FALLS CHURCH, VA, 22040-0747, US

(21) Appl. No.: 11/130,277

(22) Filed: May 17, 2005

Related U.S. Application Data
(60) Provisional application No. 60/574,582, filed on May 27, 2004.

(51) Int. Cl. G09G 5/00

(52) U.S. Cl. 345/156

(57) ABSTRACT

A small hand-held pocket-pen sized image projector device having enhancement features which include a pointing capability whereby a user can direct a laser pointing beam to a projected image and an icon identification capability for selectively orienting or otherwise controlling an image projected by the device. Also, a button type “clicking” function selection capability similar to that in a common laptop personal computer is also provided.

This application claims the priority date of Provisional Application No. 60/574,582, filed on May 27, 2004 and is intended to be incorporated herein by reference in its entirety for any and all purposes.

### RELATED APPLICATIONS

This application is related to U.S. Ser. No. 10/879,041, (Northrop Grumman Case No. 000258-078) entitled “Pocket-Pen Ultra-High Resolution MEMS Projection Display In Combination With On-Axis CCD Image Capture System Including Means For Permitting 3-D Imaging” filed on Jun. 30, 2004. This application is also related to U.S. Serial No. (Northrop Grumman case No. 000631-078) entitled “Projector Pen Image Stabilization System”. These applications are assigned to the assignee of the present invention and are meant to be incorporated herein by reference in their entirety.

### BACKGROUND OF THE INVENTION

1. Field of the Invention

This invention relates generally to a user interface for projecting a visual image on a viewing medium, and, more particularly, to a relatively small hand-held device for projecting a pointer beam on a projected image or identifying an element such as an icon, for changing a visual aspect of the image, for example, its orientation.

2. Description of Related Art

In the above-referenced related application Ser. No. 10/879,041, there is disclosed a MEMS projection display device located in the body of a relatively small sized elongated “pocket pen” type of image projection device which is capable of capturing an image and/or projecting an image, for example a color image, on a viewing surface. The device includes a very high density MEMS mirror array projection display sub-assembly for generating a high resolution image which is equal to the resolution of a conventional high end desktop personal computer. An on-axis CCD imaging array is also included in the body of the device which permits capturing of an image and which includes an overlay display capability of significant applicability such as, but not limited to, downloading of maps and/or topographical scenes. Interactivity between a transmit mode and a receive mode provides a fully-portable pen/projector/image capture device which is convenient to carry while being capable of projecting a high resolution image which can be viewed by one or more persons.

In the other above referenced related application, there is disclosed the concept of controlling the position and size of an image generated by a high resolution pen-size projector by a closed loop control system including a virtual VGA display located inside of an XGA display, a position acquisition system, a displacement compensating control system to determine a correct position of the VGA display inside of the XGA display, and a dark display area of the background portion of the XGA display.

### SUMMARY

It is an object of the present invention, therefore, to provide an improvement in image projection devices.

It is another object of the present invention to provide an improvement in hand-held image projection devices.

It is a further object of the present invention to provide an improvement in pocket-pen sized image projection devices.

These and other objects are achieved by a small hand-held pocket-pen sized image projector device having enhancement features which include a pointing capability whereby a user can direct a laser pointing beam to a projected image and an icon identification capability for selectively orienting or otherwise controlling an image projected by the device. Also, a button type “clicking” function selection capability similar to that in a common laptop personal computer is also provided.

In one preferred aspect of the invention, there is provided an imaging system for a portable image projector comprising: a portable housing; an image projector located in the housing for generating a pointing beam which is projected through a lens in the housing onto an image viewing medium; an image sensor located in the housing adjacent the lens for sensing the pointing beam on the viewing medium and generating an electrical image signal of the beam at present location thereof on the image viewing medium; circuitry connected to the sensor for generating a signal indicator of the present location of the pointing beam on the image viewing medium; a beam positioning device for changing the location of the pointing beam of the image viewing medium; circuitry connected to the beam positioning device for generating an update signal indicative of a desired new location of the pointing beam; and a video signal generator responsive to the update signal for generating a signal of the pointing beam which is fed to the image projector for imaging the pointing beam at said new location.

In another preferred aspect of the invention, there is provided an image system for a portable image projector comprising: a portable housing; an image projector located in the housing and including means for generating an image including an icon, said icon performing a certain function including conveying information to a viewer regarding a present viewed state of said image, said projector projecting the image and icon through a lens in the housing onto an image viewing medium; an image sensor located in the housing adjacent the lens for sensing and generating an electrical signal of the present state of said image and said icon on the viewing medium; circuitry connected to the sensor for identifying the icon on the viewing medium; and an image signal generator for generating a signal for altering the present state of the image in response to the viewed state of the icon, said image having an altered state thereafter being fed to the image projector for projecting a new image and icon on the viewing medium.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a longitudinal cross-sectional view of a pen-sized projector device used in connection with the subject invention;

FIG. 2 is an overlay of two rectangular grids illustrative of VGA and XGA image resolution;

FIG. 3 is illustrative of the spot-size of a laser pointer beam projected on the grid display shown in FIG. 1;

FIG. 4 is a diagram illustrative of a first use of the pen projector shown in FIG. 1 in a laser pointer mode of operation;

FIG. 5 is an electrical block diagram illustrative of apparatus used for implementing the laser pointer mode of operation;

FIG. 6 is a flow chart illustrative of the steps involved in implementing the laser pointer mode of operation;

FIG. 7 is a perspective view of the pen-type projector shown in FIG. 1 including a set of operational buttons;

FIGS. 8A and 8B are illustrative of the incorporation of an icon identification system used in connection with the pen-type projector shown in FIG. 1;

FIG. 9 is an electrical block diagram illustrative of the icon identification system incorporated in the pen-type projector shown in FIG. 1; and

FIG. 10 is a flow chart illustrative of the operational steps involved in utilizing the icon identification system.

### DETAILED DESCRIPTION OF THE INVENTION

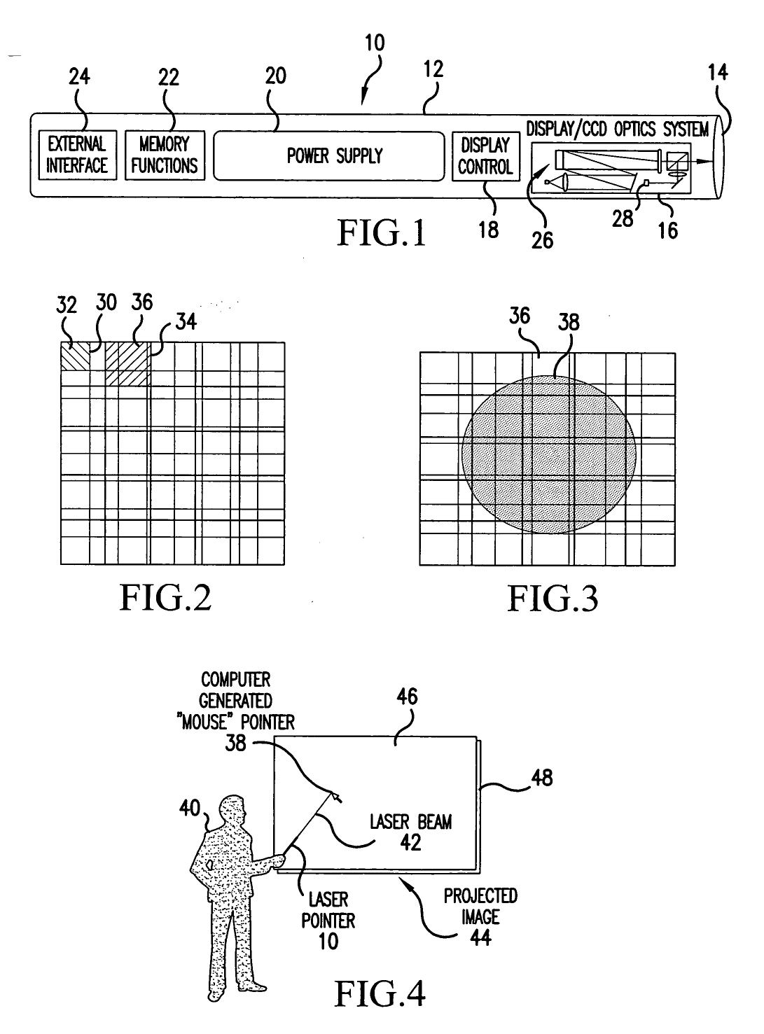

Referring now to FIG. 1, shown thereat is a pocket-pen image projector of the type shown and described in detail in U.S. Ser. No. 10/879,041. As shown in FIG. 1, the pocket-pen type projector 10 includes an elongated body 12 of circular cross section of a size to fit within the pocket of a user, not shown. At one end of the housing 12 is located a projector lens 14 located forward of a display/CCD optic system 16 which is adapted to perform two functions, the projection of an image on a viewing medium such as a wall or a screen, and for sensing and capturing all or part of a projected image.

Behind the optic system 16 is the control electronics located in a section 18 labeled as “display control”. Behind the display control section 18 is a section 20 labeled “power supply” which comprises one of two small batteries for powering the device 10. Behind the power supply section 20 is a section 22 labeled “memory functions” which includes digital memory means for images which are either to be projected or which have been received from an external source. Behind the memory section 22 is an “external interface” section 24 which may include an antenna and transmitter/receiver means for communicating with an external source for transmitting or receiving images therefrom.

The pocket-pen projection device 10 is capable of either projecting or receiving images locally via the lens 14 or image data may be electrically applied or sent to an external location via the external interface section 24.

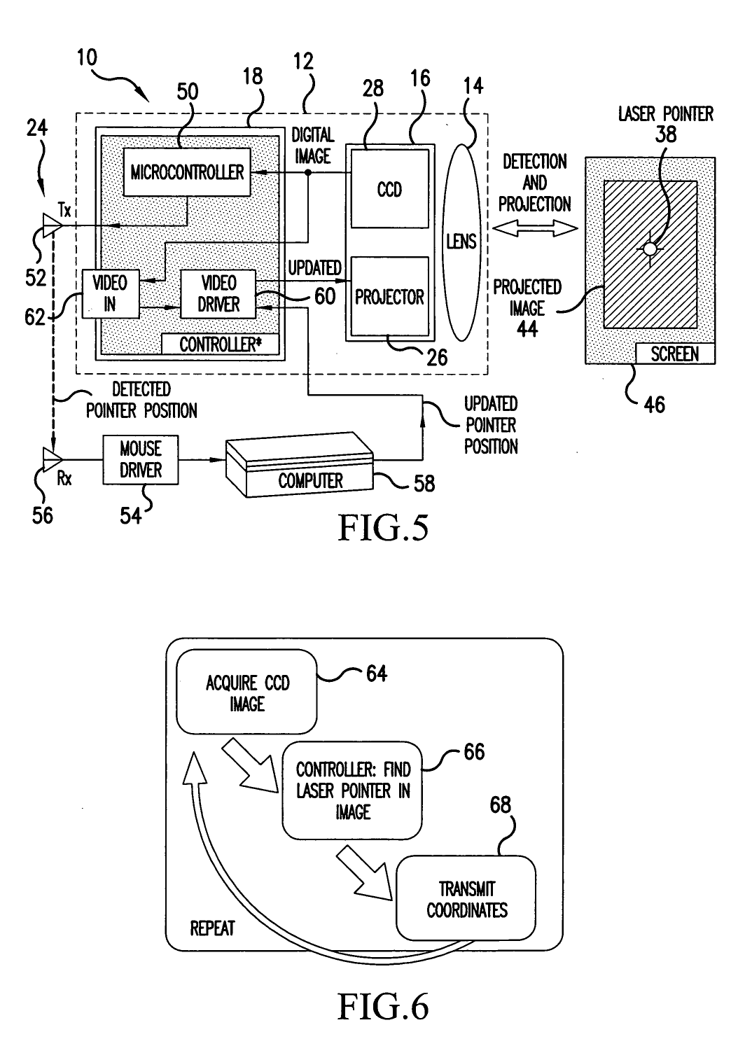

Referring now to FIGS. 2-10, shown thereat are two operational modes of the pen-type projector 10; namely: (1) a pointing system mode for projecting a laser beam onto a display; and (2) a mode for generating and projecting an icon in connection with a projected image for detecting and correcting image orientation.

Considering now the first mode, reference will now be made to FIGS. 2-7. The pen-sized device 10 shown in FIG. 1 incorporates a MEMS mirror chip 26 that projects an image onto a variety of surfaces such as a wall or a screen, not shown, and a charge coupled device (CCD) imager 28 consisting of an array of CCD elements which captures an area on which the image generated by the mirror chip 26 is projected. The resolution of the projected image is XGA (extended graphics array) which is a high resolution graphics standard (1024×768 pixels) and is normally required for projecting a map or a detailed image. The resolution of the image detected by a CCD array, however, doesn't necessarily have to be of XGA quality, and may be, for example, VGA (video graphics array) resolution of, for example, 640×480 pixels. For pointing applications, this resolution ratio will be sufficient. FIG. 2 shows a grid 30 of XGA pixels 32 overlayered by a grid 34 of VGA pixels.

In a laser pointing application, either an invisible infra-red (IR) laser or a bright color laser generated in the display/CCD optics system 16 is used in the subject invention in conjunction with the CCD imager/array to pick up or detect the location of the laser spot and send its location to a control system embedded in the display control section 18, which would then display a position indicator, for example, an arrow over the spot where the laser has been pointed.

FIG. 3 is illustrative of a spot 38 produced by a laser beam projected by the device 10 and sensed by the CCD array 28. It can be seen that the spot 28 is not the size of one VGA pixel 36 (FIG. 2). A spot size of 2 mm on a 12×9 inch projected display would take up substantially nine VGA pixels 36, assuming the beam is directly perpendicular to the display shown in FIG. 3. The beam, however, may not necessarily be circular because a user may be pointing the laser from an angle onto the display. This, however, can be remedied by averaging the center location of the laser and applying this to the display as will be shown hereinafter. With respect to any concern about the noise caused by the actual presented image, the concentrated brightness of the laser spot 38 is substantially higher than the brightness of a projected display.

Referring now to FIG. 4, shown thereat is a user 40 holding a pocket-pen sized image projector 10, such as shown in FIG. 1, which is used as a laser pointer generating a laser beam 42 to the surface of a projected image 44 where a spot 38 hits the surface 46 of the projected medium 48 which may be a wall or a screen.

Referring now to FIG. 5, shown thereat is a block diagram illustrative of a system for implementing a laser pointer mode of operation. Shown schematically in FIG. 5 is the housing 12 which corresponds to the elongated hand-held housing of the projector 10 shown in FIG. 1 and including therein a lens 14, the image projector portion 26 and CCD imaging array 28 of the display/CCD optics system 16. As shown, a projected image 44 is projected onto a screen 46 by the lens 14 and includes a laser spot 38 which can be detected by the CCD imaging array 28.

Further as shown in FIG. 5, the display controller 18 includes, among other things, a microcontroller 50 which is responsive to the digital image generated by the CCD array 16 to provide coordinate information of the position of the laser pointer spot 38 on a projected image 44. The coordinate information is fed to the external interface section 24 which includes an antenna 52 which transmits the coordinate information to a personal computer (PC) mouse driver 54 via a receiving antenna 56, thereby implementing a wireless mouse system. The mouse driver 54, in turn, is coupled to a digital computer 58 which generates updated pointer position coordinates which are fed to a video driver 60 which generates an updated image of the laser pointer spot 38 which is directed to the screen 46 via the projector 26 and the lens 14. The controller 18 also receives a projected image signal of the image 44 from the CCD array 16 which is fed to a -video input section 62 which generates the desired image to be projected via the video driver 66 as well as any movement thereof.

The system shown in FIG. 5 in effect implements a simple track function to a wireless mouse system in that the mouse driver 54 receives simple coordinates from the projector 12 where the laser pointer spot 38 should be placed within the operating system, i.e., on the projected image 44.

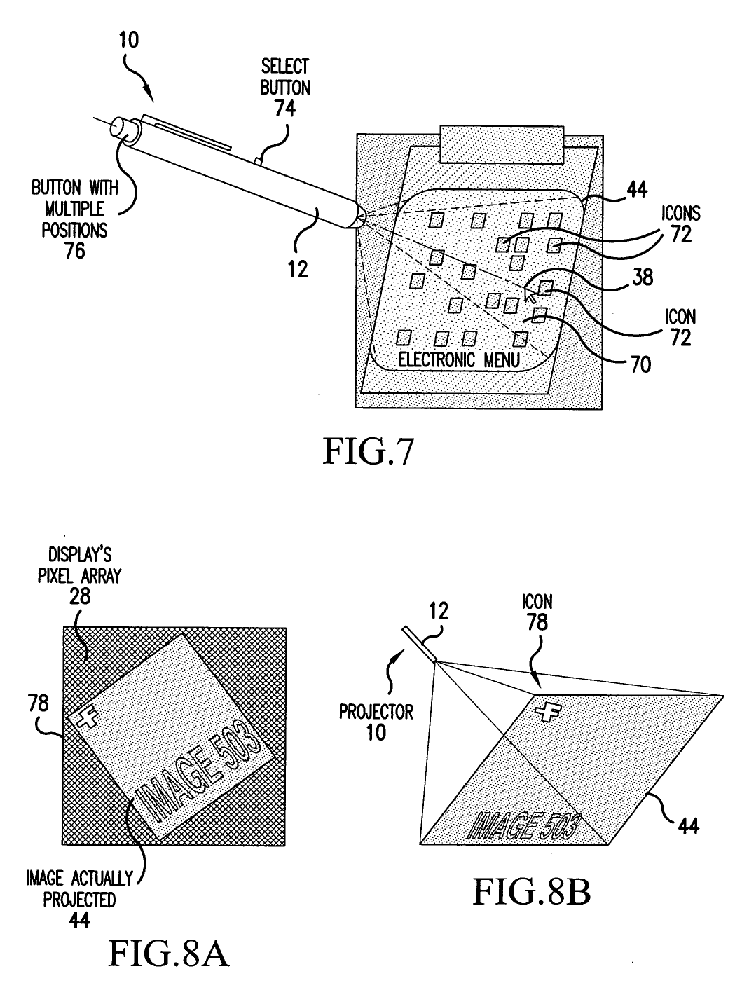

The flow chart shown in FIG. 7 is a simple flow chart of the system operation and, as shown, includes the first step 64 where the projected image 44 is acquired by the CCD array 16 which is followed by the microcontroller 48, finding the laser pointer spot 38 in the image 44 as shown by step 66. The coordinates of the laser pointer spot 38 are then transmitted to the mouse driver 54 where an updated pointer position is continuously projected onto the screen 46.

Referring now to FIG. 7, shown thereat is a modification of the pointer system shown in FIG. 5 where the pen-type projector 10 projects a laser spot 38 and an arrow 70 onto a display 44 including, for example, a plurality of icons 72. The housing also includes a “click” button 74 such as used with a conventional mouse in a desk top personal computer, for clicking onto a particular icon selected by the position of the arrow 70.

Additionally, the projection device 10 would also include a multiple position toggle button 76 which forms part of a toggle switch located inside the housing 12 which would enable the user to select several operational positions, such as: (1) an OFF position where the button 76, for example, would be pressed all the way in; (2) a first intermediate ON position where the projected image is generated; (3) a second intermediate position where an image stability function is enabled in accordance with the taching in related application Ser. No. ______; and (4) a fully out position where the button 76 provides a “wiggle” capability for positioning the spot 38 and the arrow 70.

Referring now to FIGS. 8-10, shown thereat is an operational mode for the pen-type projector 10 which provides icon identification and image orientation.

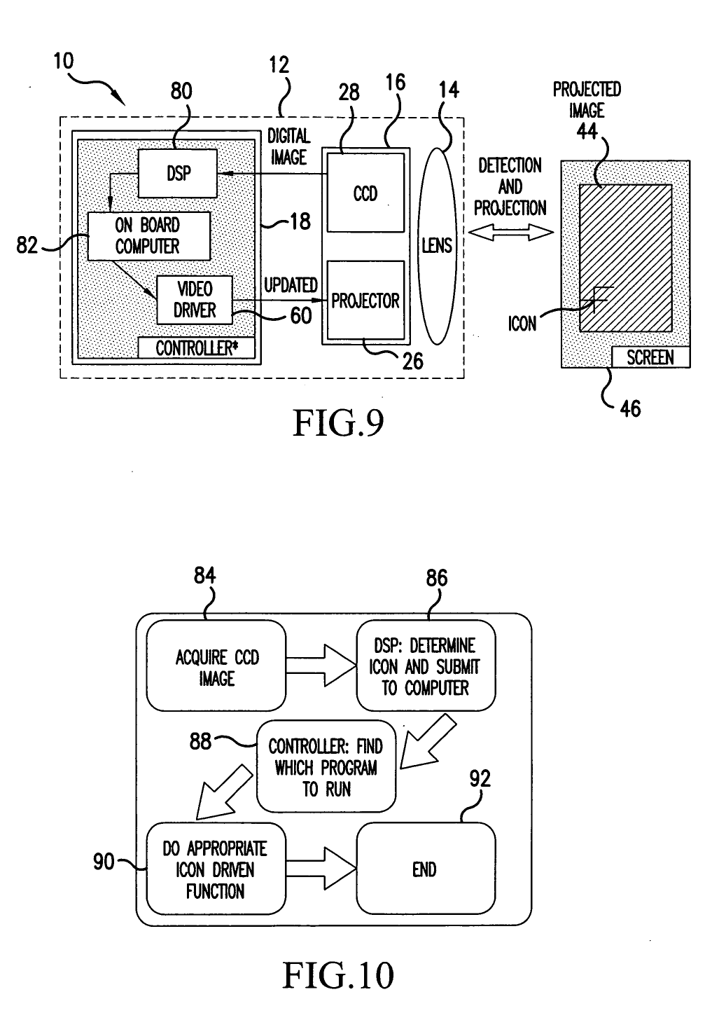

FIG. 8A discloses an image 44 actually displayed and detected by the CCD imaging array 28 shown in FIG. 9. The image 44 shown in FIG. 8A now also includes an icon 78 which provides the viewer with certain information such as the image 44 is tilted, and that the image should be rotated to make sense for the observer as shown in FIG. 8B. In this mode, the resolution of the CCD array 16 need only be proportional to the detail of the icon 78. Also, the controller 18 now includes a digital signal processor (DSP) 80, including a memory, and an on-board computer 82, including a memory table, coupled to the video driver 60 which now allows the projector 10 to be a “smart” projector so that it is able to recognize the icon 78.

Although a rotational mode is shown in FIGS. 8A and 8B, the icon 78 could define what program from a plurality of different programs the projector 10 should set itself for and what orientation the image 44 should have so as to, for example, convert it to off-center or diagonal orientation to compensate for projector position.

FIG. 10 is a flow chart illustrative of the operation of the system shown in FIG. 9. The first step shown by reference numeral 84 is to acquire the image 44 impinging upon the CCD array 28. Next, the DSP 80 locates the icon 78 and submits it to the onboard computer 82 as shown by step 86. This involves obtaining coordinates for analysis, sending the coordinates to the onboard computer 83 and retaining the coordinates in memory for more efficient search subsequently if needed. Next, the onboard computer 82 determines in step 88 what program needs to be run from a look-up table based on which type of icon is found. This is followed by step 90 which is to perform the appropriate icon driven function defined in the look-up table. Finally, step 92 ends the function being performed. This function may repeat automatically, in which case it would have to be turned off manually. Thus, if the icon has sufficient detail, there are numerous different programs that could be pre-set into the projector that are enabled by a specific icon.

Having thus shown and described what is at present considered to be the preferred embodiments of the invention, it should be known that the same has been made by way of illustration and not limitation. Accordingly, all alterations and modifications coming within the spirit and scope of the invention as defined in the appended claims are meant to be included.

1. An imaging system for a portable image projector comprising:
a portable housing;
an image projector located in the housing for generating a pointing beam which is projected through a lens in the housing onto an image viewing medium;
an image sensor located in the housing adjacent the lens for sensing the pointing beam on the viewing medium and generating an electrical image signal of the beam at present location thereof on the image viewing medium;
circuitry connected to the sensor for generating a signal indicator of the present location of the pointing beam on the image viewing medium;
a beam positioning device for changing the location of the pointing beam of the image viewing medium;
circuitry connected to the beam positioning device for generating an update signal indicative of a desired new location of the pointing beam; and
a video signal generator responsive to the update signal for generating a signal of the pointing beam which is fed to the image projector for imaging the pointing beam at said new location.

2. The system of claim 1 wherein the portable housing is in the shape and size of a pocket pin.

3. The system of claim 1 wherein the image projector includes a MEMS mirror chip.

4. The system of claim 1 wherein the image sensor comprises an array of light sensitive elements.

5. The system of claim 4 wherein said array of light sensitive elements comprise an array of semiconductor charge coupled devices.

6. The system of claim 4 wherein the pointing beam comprises a visible beam or an invisible beam.

7. The system of claim 4 wherein the pointing beam comprises an IR beam.

8. The system of claim 4 and wherein the image projector additionally generates a visual indicator at the point where the pointing beam impinges on the viewing medium.

9. The system of claim 8 wherein the visual indicator comprises an icon.

10. The system of claim 9 wherein said icon comprises a pointing icon.

11. The system of claim 10 wherein the pointing icon is in the form of an arrow.

12. The system of claim 1 wherein the beam positioning device comprises a manual device apart from the portable housing for moving the pointing beam.

13. The system of claim 12 and additionally including a wireless transmitter/receiver connection between the circuitry generating the signal of the present location of the beam and the beam positioning device.

14. The system of claim 12 wherein the manual device comprises a personal computer mouse type driver device.

15. The system of claim 1 and additionally including a manually actuated switch on the housing for locking the image sensor on to a selected portion of the image on the viewing medium.

16. The system of claim 1 and additionally including a switch on the housing for moving the pointing beam over the image on the viewing medium.

17. The system of claim 16 wherein the switch comprises a toggle switch located at one end of the housing.

18. The system of claim 1 wherein the image resolution of the image on the viewing medium is of a first image resolution and the image resolution of the pointing beam is of a second image resolution.

19. The system of claim 18 wherein the first image resolution is greater than said second image resolution.

20. The system of claim 19 wherein the first image resolution is XGA image resolution and the second image resolution is VGA image resolution.

21. An image system for a portable image projector comprising:
a portable housing;
an image projector located in the housing and including means for generating an image including an icon, said icon performing a certain function including conveying information to a viewer regarding a present viewed state of said image, said projector projecting the image and icon through a lens in the housing onto an image viewing medium;
an image sensor located in the housing adjacent the lens for sensing and generating an electrical signal of the present state of said image and said icon on the viewing medium;
circuitry connected to the sensor for identifying the icon on the viewing medium; and
an image signal generator for generating a signal for altering the present state of the image in response to the viewed state of the icon, said image having an altered state thereafter being fed to the image projector for projecting a new image and icon on the viewing medium.

22. The system of claim 21 wherein the portable housing is in the shape and size of a pocket pen.

23. The system of claim 22 wherein said icon conveys information for performing a predetermined function with the image on the viewing medium.

24. The system of claim 22 wherein the predetermined function comprises a re-orientation of the image on the viewing medium.

25. The system of claim 21 wherein the image projector includes a MEMS mirror chip.

26. The system of claim 21 wherein the image sensor comprises an array of light sensitive elements.

27. The system of claim 25 wherein said array of light sensitive elements comprise an array of charge coupled devices.

28. The system of claim 21 wherein the image resolution of the image on the viewing medium is of a first image resolution and the image resolution of the icon is of a second image resolution.

29. The system of claim 28 wherein the first image resolution is greater than said second image resolution.

30. The system of claim 29 wherein the first image resolution is XGA image resolution and the second image resolution is VGA image resolution.
